(19) United States
(12) Patent Application Publication
(10) Pub. No.: US 2011/0288905 A1
(43) Pub. Date: Nov. 24, 2011

(54) RESOURCE SUPPLY MANAGEMENT SYSTEM AND METHOD

(75) Inventor: Chris Mrakas, Oyster Bay (AU)

(73) Assignee: GREENBOX IP PTY LIMITED, South Yarra, Victoria (AU)

(21) Appl. No.: 13/148,250

(22) PCT Filed: Jan. 27, 2010
(86) PCT No.: PCT/AU2010/000078

§ 371 Date: Aug. 5, 2011

(30) Foreign Application Priority Data
Feb. 10, 2009 (AU) 2009900529

(51) Int. Cl. G06Q 50/00

(52) U.S. Cl. 705/7.25

(57) ABSTRACT

This system is for efficient consumption of a consumable or resource such as electricity, gas or the like. Each consumer site, such as a household or business, has a consumer node. The consumer node gathers consumption data from one or more consumer devices consuming the consumable. A central node is in communication with the consumer nodes and determines a collective consumption of the consumable across the plurality of consumer sites. The central node participates in live markets in order to secure delivery of the consumable as required collectively across the plurality of consumer sites. The central node communicates market data conveying substantially live market effects to the consumer nodes, and the consumer nodes process the market data in a manner to influence consumption of the consumable, for example by deactivating devices during market peaks.

### TECHNICAL FIELD

The present invention relates to the supply of resource consumables such as electricity, gas, water and the like within a deregulated or partially deregulated market to consumers such as domestic households and businesses. In particular the present invention provides a system and method for facilitating and rewarding both consumers and suppliers for efficient consumption of such consumables.

### BACKGROUND OF THE INVENTION

In markets which deregulate electricity and adopt a pool market (also known as Spot or Wholesale Market or similar term) wide fluctuations in wholesale electricity prices can arise. It is desirable that the risk posed to market participants be addressed. Derivative contracts, being an agreement between commercial parties containing a binding obligation to deliver electricity at a specified location for a nominated price, allow market participants to hedge against the risk of adverse movement in the price of electricity. Such hedging instruments are of value to electricity generators and retailers. However, they are impractical to retail consumers at least due to (a) the very large buying volumes, with the minimum trading threshold volume being enough to supply about 1000 typical households, (b) the complexity of derivatives trading via derivatives markets or over-the-counter trading, and the complexity of maintaining a net position in which consumption and hedge position are balanced, and (c) the need for a strong credit worthiness to even participate in such trades. Thus, consumers wishing to buy electricity at spot prices and manage their own price risk are unable to do so because they effectively do not have access to retail electricity hedge contracts to address their risk exposure. In addition to the above market conditions are additional prices known as tariffs which are incurred outside of the spot market but are directly related to the electricity consumption of the household. This includes, but is not limited to, distributor charges for the carriage of electricity on their infrastructure to the household.

Instead, consumers' dealings with retailers involve a regulated tariff which incorporates a risk premium for the retailer hedging for wholesale electricity prices and an ad-valorem profit margin. While a regulated tariff calculated in such a manner insulates the consumer from market involvement, it acts as a disincentive for the retailer to minimise their operating cost base because under the ad valorem arrangement the retailer profit increases with increasing cost base, with the effect that consumers will tend to pay more. Moreover, insulating consumers from market prices gives consumers no financial incentive to improve energy efficiency during market peaks.

Similar considerations apply to consumables other than electricity for which a deregulated or partially deregulated market exists.

Moreover, existing infrastructure for delivering a consumable does not provide a consumer with any indication of the substantially real-time market conditions for that consumable, nor with any indication of how the consumer may benefit from such conditions.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a system for efficient consumption of a consumable, the system comprising:
a plurality of consumer nodes each associated with a respective consumer site, each consumer node for gathering consumption data from one or more consumer devices consuming the consumable; and
a central node in communication with the consumer nodes, for determining a collective consumption of the consumable across the plurality of consumer sites, for participating in live markets in order to secure delivery of the consumable as required collectively across the plurality of consumer sites, and for communicating market data conveying substantially live market effects to the consumer nodes;
wherein the consumer nodes are operable to process said market data in a manner to influence consumption of the consumable.

According to a second aspect the present invention provides a consumer node for facilitating efficient consumption of a consumable, the consumer node being associated with a consumer site and being operable to collate consumption data gathered from one or more consumer devices consuming the consumable and communicating collated consumption data to a central node for use in collective market participation, the consumer node further being operable to receive from the central node market data conveying substantially live market effects and to process said market data in a manner to influence consumption of the consumable.

According to a third aspect the present invention provides a central node for facilitating efficient consumption of a consumable, the central node being operable to receive consumption data from a plurality of consumer nodes each associated with a respective consumer site and determine a collective consumption of the consumable across the plurality of consumer sites, the central node further being operable to participate in live markets in order to secure delivery of the consumable as required collectively across the plurality of consumer sites, and the central node further being operable to communicate market data conveying substantially live market effects to the consumer nodes for influencing consumption of the consumable.

According to a fourth aspect the present invention provides a method for efficient consumption of a consumable, the method comprising:
a plurality of consumer nodes, each associated with a respective consumer site, gathering consumption data from one or more consumer devices consuming the consumable;
a central node communicating with the consumer nodes, determining a collective consumption of the consumable across the plurality of consumer sites, participating in live markets in order to secure delivery of the consumable as required collectively across the plurality of consumer sites, and communicating market data conveying substantially live market effects to the consumer nodes; and
each consumer node processing said market data in a manner to influence consumption of the consumable.

According to a fifth aspect the present invention provides a computer program product comprising computer program code means to make a computer execute a procedure for providing a central node for facilitating efficient consumption of a consumable, the computer program product comprising:
computer program code means for receiving consumption data from a plurality of consumer nodes each associated with a respective consumer site and for determining a collective consumption of the consumable across the plurality of consumer sites,
computer program code means for participating in live markets in order to secure delivery of the consumable as required collectively across the plurality of consumer sites, and
computer program code means for communicating market data conveying substantially live market effects to the consumer nodes in a manner to influence consumption of the consumable.

According to a sixth aspect the present invention provides a computer program product comprising computer program code means to make a computer execute a procedure for providing a consumer node associated with a consumer site, the consumer node for facilitating efficient consumption of a consumable, the computer program product comprising:
computer program code means operable to collate consumption data gathered from one or more consumer devices consuming the consumable;
computer program code means operable to communicate collated consumption data to a central node for use in collective market participation;
computer program code means operable to receive from the central node market data conveying substantially live market effects;
computer program code means operable to process said market data in a manner to influence consumption of the consumable at the consumer site.

According to a seventh aspect the present invention provides a derivative instrument comprising:
a forward contract specifying a period and price for which a consumable will be delivered, at a specified volume; and
at least one swing option, which may be exercised only at defined dates within the period of the forward contract, and which permits alteration of the specified volume for the remainder of the stated period, at a strike price.

According to an eighth aspect the present invention provides a computer program product comprising computer program code means to make a computer execute a procedure for administering a derivative instrument in accordance with the seventh aspect.

According to a ninth aspect the present invention provides a consumption management device for facilitating efficient consumption of a consumable, the consumption management device comprising:
a consumption monitor configured to obtain consumption data reflecting consumption of the consumable at the consumption management device; and
a data transmitter for transmitting the consumption data to a consumer node for communication to a central node for use in collective market participation.

The consumable may be electricity. In such embodiments, where the consumer is a domestic household the monitored consumer devices may comprise one or more of: a television, a hot water unit, an oven, an audio system, an air conditioner, a central heating unit, or other domestic electrical appliance. In such embodiments, where the consumer is a business the monitored consumer devices may comprise one or more of: a server facility, an air conditioner, a central heating unit, a factory production device, a motor, a tool, or other electrical device.

Alternatively, the consumable may be gas, water, petrol (gasoline) or other such commodity consumed at retail level by consumers and for which a pool market or the like exists. This includes, but is not limited to, consumables such as petroleum (gasoline), water and natural gas. Example markets susceptible to application of some embodiments of the invention include the National Energy Market (Australia), Nord Pool (Scandinavia) and National Balance Point (UK). Some embodiments of the invention can apply to similar market constructs that may form in the future such as for Hydrogen, BioFuel and Broadband.

The consumption data gathered from the one or more consumer devices may comprise: data reflecting total consumption of the consumer site; and/or data reflecting a subset of consumption such as one of a plurality of power circuits within the site; and/or data reflecting consumption of one or more elements within the site such as a consumption management device, multi-socket power-point or power-board; and/or data reflecting consumption of individual devices.

The consumption data may reflect an instantaneous rate of consumption, and/or may reflect cumulative consumption for a period of interest. Preferably, substantially all devices consuming the consumable at the consumer site have their consumption monitored. The consumption of one or more areas of the consumer site may be monitored in lieu of monitoring individual devices within each such area, for example a power circuit supplying a kitchen may be monitored by a smart monitor or statistical meter in lieu of monitoring the consumption of each individual device in the kitchen.

The consumer devices may be in wireless communication with the consumer node in order to effect collation of the consumption data, such as by way of Zigbee, Bluetooth or other suitable wireless communications protocol Additionally or alternatively the consumer devices may be in wired communication with the consumer node, for example by way of Ethernet or power line communications protocols. The consumer devices may possess in-built network-enabled consumption monitors operable to communicate with the consumer node. Alternatively the consumption of the consumer devices may be monitored by a separate network-enabled monitoring device.

The consumer node, when processing said market data in a manner to influence consumption, may simply display the market data for viewing by persons at the consumer site, such that those persons may conveniently take market conditions into account in deciding how to consume the consumable. That is, the consumer may alter behaviour to reduce consumption based on energy feedback. However, in preferred embodiments the consumer node uses the market data to control the operation of at least one of said consumer devices in response thereto. In preferred embodiments of the invention, the consumer node uses the market data to control the energy consumption in a manner defined by the associated consumer. For example the consumer may elect to program the consumer node to undertake load shifting in response to peak periods such that time-insensitive devices are operated only during off-peak periods. Alternatively the consumer may elect to program the consumer node to undertake peak clipping during peak periods such that nominated inessential devices are deactivated or partially deactivated by the consumer node. Moreover, in some embodiments control of the consumer devices may be effected in a site centralised manner by the consumer node controlling all site devices. Alternatively control may be effected in a distributed manner by site sub-nodes such as programmable logic controllers each controlling one, or a subset, of the consumer devices.

Consumption may be changed substantially immediately to respond to a current market condition, or alternatively may be varied to respond predictively to anticipated future market conditions. Consumption may for example be controlled in order to constrain consumption for a given period below an agreed amount, to allow the consumer to sell back an unused portion of the agreed amount. The given period might for example be the term of a plan entered into by the consumer, or may be a portion of the term such as a three month period.

In preferred embodiments of the invention, a consumer associated with each consumer site enters into an agreement, referred to as a plan, with a retailer (or other direct to consumer agent) associated with the central node. Under such a plan the consumer nominates a required supply of the consumable and a time period for which the supply is required, effectively entering into a futures contract for supply of the consumable. Preferably, within the terms of the plan the consumer further nominates the anticipated variation in supply volume which may be required during the period of supply. Such embodiments enable the retailer to aggregate a plurality of relatively small futures contracts into a single pool of sufficient size for trading or over the counter (OTC) arrangements with suppliers of the resource, for example in the case of electricity such suppliers being Electricity Generators. Moreover, such embodiments give the consumer price certainty and insulate the consumer from price fluctuations.

Embodiments in which each consumer enters into a plan preferably further provide for the consumer to sell back unused portions of the consumable as defined in the plan, and/or purchase additional amounts of the consumable beyond the amount specified in the plan, and/or transfer or donate amounts of the consumable to other parties. Such plans may require a rolling component such as 12 months into the future to secure ongoing provisioning of a consumable at a fixed price. Such embodiments of the present invention provide a significant benefit in that unused resource (e.g. energy) has traditionally been difficult for retailers to monetise. Moreover, consumers may benefit from selling back (sell back) resulting excess resource (e.g. electricity). Such benefits can include financial and non financial rewards. The retailer may further offset a sell back by one consumer against a purchase by another consumer within the same futures pool, thus avoiding the need for the retailer to turn to the markets to service change requests which can instead be offset within the pool. The retailer may themselves sell back portions or enact a swing option on their OTC derivative for the wholesale resource depending on market conditions. Embodiments involving such a plan are made possible by the system of the present invention providing ongoing, and preferably near real-time, monitoring of consumer consumption.

In some embodiments of the invention the consumer node may also provide other site functions such as security monitoring, medical device monitoring or the like.

In embodiments in which the energy retailer obtains communications bandwidth for communication with the plurality of consumer nodes, bandwidth not used for this purpose may advantageously be retailed for other purposes such as user broadband connectivity, user voice over IP connections, and the like.

The consumer may comprise a group of individuals resident in one or more domiciles.

The central node may be effected by a retailer, wholesaler or generator of the consumable. The central node may be implemented by a server, server farm, or by cloud computing.

Participation of the central node in live markets may be effected by way of an agent.

In embodiments of the ninth aspect, the consumption management device may comprise a multi-socket power point or power board, having power monitoring and reporting capability. The consumption management device may further comprise: a data receiver for receiving instructions from the central node as to how consumption should be controlled; and a processor for controlling consumption of the consumable at the consumption management device in accordance with received instructions.

### BRIEF DESCRIPTION OF THE DRAWINGS

An example of the invention will now be described with reference to the accompanying drawings, in which:

FIG. 1 illustrates an electricity supply management system in accordance with one embodiment of the present invention;

FIG. 2 illustrates a general-purpose computing device that may be used in an exemplary system for implementing the invention;

FIG. 3 illustrates the system architecture of elements making up the electricity supply management system in accordance with FIG. 1, and further illustrates software modules executed by each element to effect operation of the system; and

FIG. 4 is a flowchart illustrating user registration and management in accordance with the described embodiment of the invention.

### DESCRIPTION OF THE PREFERRED EMBODIMENTS

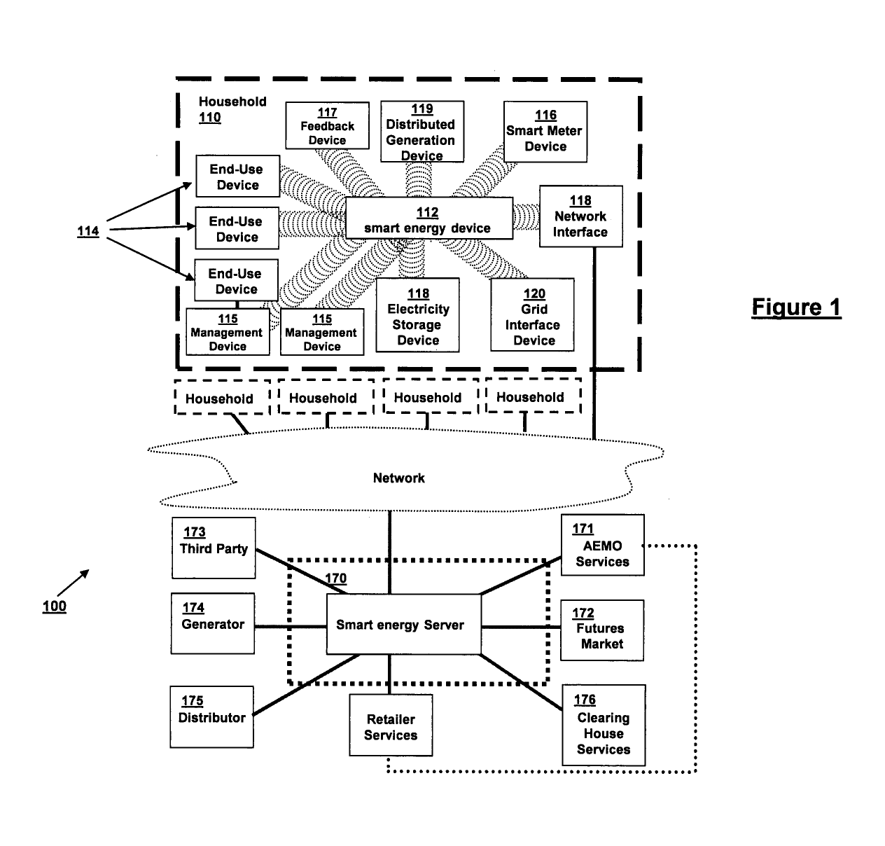

FIG. 1 illustrates an electricity supply management system 100 in accordance with one embodiment of the present invention. A household 110 is connected over a network 140 to a central node 170. Household 110 comprises a consumer node 112 which is wirelessly connected to end use devices 114 which consume electricity either directly or through a connected management device 115 (such as a smart powerboard), the consumer node 112 monitoring the electricity consumption of the devices 114 in substantially real time. The consumer node 112 also communicates with a smart meter device 116 which indicates the overall electricity consumption of household 110. Smart meter device 116 is also for reconciliation of the consumer node 112 with other consumption collection mechanisms or with management devices 115 (such as a statistical meter or smart power board) that aggregates a subset of overall electricity consumption, and communicates to central node 170 by way of a separate network interface 118. The local wireless network within household 110 may be effected by Zigbee, Bluetooth, or any other suitable wireless network arrangement. Such network within household 110 may also be connected to other households between consumer nodes 112 as an alternate network path to the central node 170. Access to market, retail, and energy information can be obtained via a range of Feedback devices 117 such as a Personal Computer, Television and portable digital screens.

As shown, in FIG. 1, other households and businesses are connected in similar manner to the central node 170.

The central node 170 gathers electricity consumption data from the consumer node 112 and administers the energy plan entered into by each consumer.

A plurality of households such as household 110 each make a binding offer to the managing entity associated with the central node 170 to buy energy for a commitment period (for example, 1 year) at a maximum price. Consumers can do this independently using the internet or in person through services provided by the retailer to make such a binding offer. On receipt the managing entity has a set number of days to commit to this price and to declare the starting date of the electricity service, this period is called the “pooling period”.

During this pooling period the managing entity undertakes several portfolio analyses to aggregate various combinations of different consumer offers into valuable energy pools known as “parcels”. This pool analysis optimizes the value of each parcel to the managing entity by applying portfolio theory, behavioural modelling and environmental and consumption forecasts to the parcel and to the total portfolio of parcels under management by the managing entity. A parcel can be viewed as the encapsulation of commercial terms applying to all households within that parcel. Within this parcel all householders share identical terms and energy can be readily offset amongst the households at these pre-determined terms.

Whenever offsetting is required to occur from outside a parcel this occurs using the benchmark rate set by the managing entity for the period. This benchmark rate is the rate that would have applied to a notional parcel of energy.

Having assembled one or more energy parcels the managing entity is then able to purchase a derivative energy contract referred to as a swing option bilateral agreement (SOBA) (described further in the following) on futures market 172, or by a forward contract from a party who has the capacity to perform such as a Generator 174, to offset the obligation to deliver energy to the consumers so aggregated within the said parcels.

An expression of interest (EOI) is a binding offer from household 110 that, if accepted within a stipulated period, binds the household consumer with the managing entity to create the business relationship. The EOI sets out the terms on which such a relation will be formed. In this embodiment the EOI contains SOBA information such as variations, commitment volumes, quality, prices, service commencement date, term, value pool sharing arrangements and the grace period for which the offer is valid.

Once a wholesale derivative energy contract is locked in (purchased) it can be notionally allocated to a collection of parcels. It is possible for the allocation to mismatch the aggregated energy commitment in the said parcels. That is it may be over allocated, under allocated or perfectly allocated. Having a mismatch implies that the managing entity is taking a market position and therefore is carrying or mitigating a risk. This allocation of a SOBA to parcels is a function of risk management in that a position is formed as to the likely aggregated energy consumption across the parcels being offset.

To enable sufficiently accurate positioning by the managing entity, on an half hourly (or alternate time incremental that is acceptable) basis energy consumption at the householder is monitored and a real-time or near real-time consumption to date position is determined as well as a dead-reckoning of likely future position for the householder, parcel and the overall business of the managing entity. Dead-reckoning position is a shadow process that predicts the likely consumption based on a householder's profile and associated correlations. Accuracy of dead-reckoning into the future is expected to improve as knowledge and insight of a householder 110 improves and as more and more household end-use devices are registered and monitored. Dead-reckoning is undertaken and has an associated probability of accuracy. This unique dead reckoning capability is used by the managing entity whenever it needs to estimate future consumption, and/or when access to the householder's consumer node 112 has been rendered blind, for example by network issues or faults.

A householder is monitored for to-date and dead-reckoned consumption which may be in excess or deficit (and sometimes neutral) to their respective energy commitments. Position of consumption is further qualified by period, for example year-to-date, month-to-date etc. Where a householder is in excess kWh-to-date they have excess kWh to sell to others, this is referred to as excess-kWh-to-date (abbreviated to e-kWh-TD). Where a householder has excess kWh dead reckoned this is referred to as excess-kWh-dead-reckoned (e-kWh-DR), this or part-of may be sold. Where a householder is in deficit kWh-to-date (d-kWh-TD) they must top up their usage by acquiring kWh from the retailer or via the retailer from other consumers. Where a householder is in deficit kWh dead reckoned this is a warning that they may well need to top up.

The central node 170 nets off all households in a parcel and arrives at a parcel MWh position which may either be deficit or excess to-date as well as (deficit or excess) dead-reckoned. Where a parcel is in excess MWh to-date (e-MWh-TD/P) this may be sold. Where a parcel is in excess dead reckoned (e-MWh-DRIP) this could be sold however may be at risk. The central node 170 also nets of all parcels and arrives at a position for the managing entity, either a deficit or excess (e-MWh-TT/G or d-MWh-DR/G). In summary this company position of the managing entity is the aggregation of all households over all parcels against all SOBA.

A key issue in aggregation of consumer derivative contracts in this embodiment is monetization of the excess energy as well as price risk associated with overruns in consumption. The nature of electricity is that it has to be consumed as available therefore a need exists to deal with unders and overs of consumer (retail) derivatives once aggregated from the consumer pool. That is, there remains a question of how e-MWh-TT/G or d-MWh-TT/G is addressed. The solution employed in this embodiment is swing options bilateral arrangements (SOBA). SOBA are a new broad class of derivative that is an amalgamation of a forward contract and one or more call option(s). A SOBA is often bundled together with a standard base-load forward contract that specifies for a stated period and a determined price the amount of the commodity to be delivered over that period. And the swing portion of the SOBA allows flexibility in the delivery amount around the amount of the base-load contract with attached series of rights. While in this embodiment the SOBA relates to the base-load requirement, in other embodiments relating to other types of consumable it is to be understood that a SOBA may be applied and relate the volume of the consumable required.

Due to their uncharacteristic nature SOBA are classed as exotic options (financial derivative) and what renders them valuable is that they serve a very useful purpose for addressing volume risk. SOBA are very useful in a market subject to repeated, unpredictable, price spiking that is characteristically followed by waning to normal levels (where prices generally revert to a long term mean). Therefore SOBA can be seen as an insurance for the holder against excessive rises in electricity prices where one has exposed volume. SOBA allows the holder to exercise a certain right multiple times over a specified period but only such right at a time or per time-interval. A common feature is to allow the holder to exercise a real valued multiple of a call or put option at once, where the multiple is a volume for example MWh. This generally involves further restriction on the volume fluctuations and sets upper and lower bounds for each right, and will impose a sum of all trades over the period. The forward contract portion of a SOBA supplies the holder with a constant stream of energy (MWh) to a fixed pre-determined price ($/MWh). If the strike price of the embedded call options of the SOBA is set to the forward price, the swing contract will allow for the desired flexibility in the volume (MWh) and the holder receives for the fixed price. SOBA can either swing up or down the volume of energy hence the name ‘swing’. And in the absence of other restrictions it will always be optimal to swing the maximum allowed amount.

Each right, if exercised on a given date, allows the holder of the swing contract to choose an incremental volume that may be positive or negative. When positive the holder receives an increased amount of the underlying commodity (MWh) and when negative the holder decreases the base-load volume or equivalently delivers that amount. Whenever the opportunity arises the holder of a SOBA must choose whether to exercise by some amount and receive some immediate payoff. In so doing the holder gives up a matching amount of the optionality within the SOBA. In effect the holder is exchanging the option for one that is less valuable.

A SOBA is an exotic derivative used to purchase or sell electricity over a given time period at a specified price, with some constrained flexibility in the volume and the timing. The primary contractual elements of SOBA are two components (i) a pure forward agreement, and (ii) a swing option made up of multiple puts/calls. Key Characteristics of the SOBA are:—
The holder is allowed to choose between various levels of the swing, upwards or downwards (positive or negative) around baseline;
There are limits imposed on the net accumulated swing (cumulative volume MWh) during the contract period and also on the frequency of swings as well as the total absolute value of swing (ie a swing entitles the owner to exercise up to “x” rights);
In all cases a right can be exercised only at a discrete set of dates at most one right exercised on any given date;
A minimum refraction time between swings is obligatory which limits the next time a right can be exercised;
The decision to swing may cause a change to the rate of consumption for the contract residue for a duration. This duration of the swing effect (associated with the exercise of a right) is defined and affects the baseline volume. For example (a) where the exercise of a right modifies the delivery volume only on the date of exercise and the delivery reverts to the baseline level specified in the base-load contract thereafter, or (b) where the exercise of a right modifies the delivery volume baseline beginning on the exercise date and the delivery remains at the new baseline level until the next exercise, if any.
Where baseline ratcheting has been invoked further limits can be overlaid on the rate at which this baseline can be changed, or the total number of times it can be changed;
The decision to swing requires a notice period before the volume is adjusted;
Penalties for breaching limits may be imposed to discourage the behaviour. Such violation may be allowed, but would lead to penalties settled at expiration (either a one-time penalty or a per-unit (MWh) violation penalty). The penalty rate could be predetermined on entering of the SOBA or depend on a random observable price at expiration to determine the penalty rate (ie spot price at expiration, or the maximum spot price over a period).

The SOBA counterparty to the managing entity is the generator 174 who has a need to offset their position and requires alternative channels to sell their energy. Straight Through Processing (STP) enables the managing entity and a Generator 174 to effect SOBA for a parcel cost effectively and efficiently. All swings are aggregated and reconciled to the Generator 174 in summary to reduce the back-office work as well as to minimise cost required by the Generator 174 and the managing entity. In the present embodiment adapted for Australian markets, AEMO (previously NEMMCO) uses a billing period of a week, this therefore becomes the level at which swings are exercised. This period is called “pool market billing period” and is currently seven days if it should change to finer resolutions the managing entity will calibrate this period within its SOBA. The degree of Swing defined for SOBA used to off-lay a parcel may vary based on the properties of the parcel. It is to be noted that in alternative embodiments in other jurisdictions and/or relating to other types of consumable, swings are preferably exercisable under the SOBA with a regularity corresponding to the applicable billing period. A SOBA can offset any prudential requirements of the energy regulatory body in markets where the market operator permits this. In this embodiment, AEMO allows market participants to negate cash requirements from OTC arrangements by a process called settlement reallocation with Generators.

Also contained within the SOBA is a “Buy Back” option that allows the parties to mutually agree to ad-hoc volume alterations (MWh in this embodiment) to optimise prevailing market conditions. This allows the managing entity to either offload excess energy, curtail energy or take a market position with associated risk.

Crucial in all derivatives is the creditworthiness of the parties to perform. The managing entity must have a series of settlement accounts with a number of clearinghouses 176 to be able to undertake trades. These settlement accounts have a defined credit-limit which backs trades that may fluctuate based on a number of factors. As such the credit-worthiness of the managing entity must be propagated at the consumer level. Each consumer must have corresponding credit-limits associated to their accounts that underpin their credit worthiness, this in turn is aggregated to the managing entity's level.

For Household consumers, prior to providing a credit account to a household applicant, or during the life of such a household credit account, the managing entity will need to know whether the household will be or is likely to be within the “credit-risky” population. The credit-risky population includes those customers that are unlikely to make payments as and when they fall due. However, in this embodiment and by virtue of creating a managed plan between the customer and retailer the preferred position is to remove the risk by pre-payment as opposed to payment in arrears which is the current industry practice. Prepayment creates a positive working capital position and reduces financial stress on the managing entity to finance working capital.

While the present embodiment is focused on the asset class of electricity, it is to be appreciated that such concepts also apply to a broader range of asset classes termed consumables. Particularly for those commodities that are consumed by a consumer at a retail level and are subject to similar spikes in price volatility also these commodities are sourced from wholesale markets (pool markets). Gas is a good example of such a commodity.

Accordingly, the central node 170 and/or consumer nodes 110 are able to accommodate expansion of asset classes, to cater for immediate asset classes including electricity and gas, and allowing for expansion to include water. It is further envisioned that the present invention may be applied to include petrol (gasoline) once the ability to measure consumption in real-time for such commodities is implemented. It is further envisioned that should broadband develop a wholesale pool market this consumable can also be implemented as an asset class.

The managing entity creates a value pool which is shared with a consumer 110 using various value sharing schemes. The value pool (also known as a Bonus Pool) represents monetized value that a consumer 110 will benefit from. The Value Pool is composed of a number of financial elements which cause the pool to increase, these are:—(a) sell back of excess energy at a prescribed rate, (b) carbon abatement (monetized), (c) subsidies from government agencies, (d) reward bonus for attainment of efficiency goals, (e) curtailment bonuses (monetized), and (f) feed-in tariffs (after nettings) provided by various authorities.

In some embodiments the value pool also will incorporate a share of net trading results from exploiting price spikes in the wholesale markets.

The value pool may be shared between the managing entity and the consumer. This sharing arrangement is determined on entry into a plan and defines the sharing at a Value Pool financial Elements level. In the present example monetized carbon abatements are wholly for the consumer whilst the sellback is shared 60/40 for the managing entity/consumer. Such arrangements can be varied to take into account prevailing market competitive conditions. The Value Pool is distributed periodically and can vary as a policy however it applies globally across all consumers of the managing entity. For example annually, every quarter or monthly. The payment mechanism for the value pool is in the form of a credit entry (rebate) on a consumers account, cash, negotiable instruments, or a form of reward for a consumer loyalty program.

The managing entity must in this embodiment construct a price for a commodity bottom up for a parcel of consumers. For electricity this approach embeds all known costs for the consumption of electricity by the parcel over the commitment period. Components of the price build are known as price build elements, these elements are formulae in nature and may contain a standing charge (e.g. meter charges, meter data charges) as well as volumetric charges for the resource, as well as government and market operator charges and taxes. Some charges are location specific based and are influenced by the energy market (ie NEM), state jurisdiction, and network operator (Distribution Business or Network Operator in NEM).

The control node 170 contains a database of such price build elements and these are levied for defined periods. The control node 170 ensures that where a commitment period straddles price build element periods, the correct pricing is undertaken. All price build elements are set according to a contract either bilateral in nature or generally published (for example in the Australian market by IPART hearings in NSW or Essential Services Commission, ESC, hearings in Victoria).

Sellbacks are the sale by a consumer 110 of unused energy obligations in a plan within a billing period. The sellbacks are in lots particular to the commodity in question. For electricity the initial lots are peak and off peak and in some locations shoulder. The lots Off-Peak, shoulder (where used) and Peak are defined as particular times frames in a week and they are mutually exclusive, without gaps. It is possible for peak and off-peak periods to vary however not within the active term of a plan. It is further possible to define quality lots for a commodity for example clean (renewable), regular (coal) or blended energy (renewable and coal).

Sellbacks are sold back to the managing entity at a rate defined on plan commencement. This rate can be adjusted with the agreement of both parties during the term of a plan. For some commodities such as electricity, peak and offpeak relate to time of day whereas for other commodities such as gas, peak and off peak may relate to the season (winter or summer) and the present embodiment will manage this variance in lots.

In the present embodiment the managing entity further enables groups to pool their plans, this is marketed as “inner-circle”, or otherwise known as community-plans. Within the system 100 a consumer can become a member of an inner-circle of friends who have agreed amongst themselves to be treated as a single entity whose energy plans are aggregated and for all respects treated as such. Therefore any excesses and shortfalls are applied to the Inner-Circle group as a whole and apportioned according to actual volume consumed.

The managing entity provides facilities to enable these communities to manage their constituent membership, who are jointly and severally liable for the inner-circle plan. An inner-circle member's excesses/shortfalls are aggregated and the net position is distributed amongst the members in a pro-rata fashion. Each member still retains their own value-pool however the complication is that the excess/shortfall is determined after being netted across the group. This feature introduces the potential of excessive liabilities therefore the managing entity has the capabilities to notify members of a community of their position as a community, and as individual members.

In this embodiment the plan has a term expressed in months and this is usually tied to a purchase of infrastructure such as a smart box (the consumer node 112). This is known as a plan term, and for example 36 months term would be called a 36 plan term. Energy commitments are legal obligations to purchase energy using a unit of measure (kWh for electricity) for a particular lot of energy (peak, off-peak) for a particular quality of energy (renewable, regular, blended). The term for an energy commitment (commitment period) is less than the plan term and initially on inception of system 100 will be one year. This may become even finer in resolution, for example 90 days.

A consumer commits to buy a total volume plus or minus volume-variance (typically 20%) over that energy commitment term at an agreed fixed rate for a particular lot and quality. Over the commitment period a consumers consumption may be non linear and may widely vary. For example they may consume more gas in winter and more electricity in summer, more water in summer and less in winter. Therefore in central node 170 the demand curve for a particular commodity is derived on behalf of a consumer 110. The commitment period is broken down into settlement periods and billing periods. Settlement periods reflect the underlying commodity. For example for electricity under the NEM in Australia this is weekly, in other energy regions this may be daily or even in some locations as fractions of an hour. The settlement period is the minimal period on which a consumer's position against their obligations is netted. A lead-time before the settlement period (typically a day for electricity) the consumer's position is determined and their surplus or shortfall is determined.

Consumer 110 is billed for a billing period which is made up of one or more settlement periods. And there is a potential for a settlement period to straddle a billing period, where this occurs and with reducing complexity the managing entity manages this by including the settlement period in the next billing period. All payments are made against each billing period. Where a customer has a value pool this is applied according to policy.

Due to the inherent complexity of determining future consumption the control node 170 assumes that consumers do not readily possess the ability to construct a demand curve for their future consumption. To assist the consumer in buying wiser this capability is provided by the control node 170 and the consumer node 112 for the benefit of the consumer. For each asset class the specifics for the demand curve are unique however the operation is consistent and the output is usually the volume of a commodity by time by lot and quality.

The control node 170 can provide the consumer node 112 with a ranking of the consumer node as compared to other consumer nodes to enable the consumer node to test their demand curve with a comparable population of like consumer nodes in terms of profiling characteristics that include but are not limited to lifestyle, devices installed, family composition, stage in life, structure and size of dwelling and geographic location and orientation of dwelling. This peer ranking is provided continuously to assist the consumer node in having a comparable reference point.

For energy the consumer by providing their unique national metering identifier (NMI) (in the NEM, within Australia) enables the consumer node 112 to extract a pre-loaded database of NMI or access a pre-loaded database of NMI and their corresponding consumption histories where this exists and is within the retailer's authority to do so. An energy audit either self performed by the customer or through consultation can complement or replace data obtained via the NMI. The consumer node 112 matches the period of residence at a location with NMI consumption. The consumer node 112 also overlays profiling information known about the consumer. The consumer node 112 also collects information about the characteristics of the household 110 in terms of end use devices, family profiles, and household characteristics, as input into the demand curve generation. The consumer node 112 also has a forward-looking view of the environment for the commitment period for the demand curve. For energy this includes Heating Degree Days (HDD) and Cooling Degree Days (CDD) by day probability weighted by location. For water asset class this includes cumulative rainfall. The consumer node 112 generates a demand curve for the household based on information supplied, forward looking environmental factors and algorithms and takes into consideration lifestyle choices, changes and events. This demand curve can be readily manipulated by the householder 110 should they choose to do so. A householder once satisfied with their demand curve can lock this into their commitment obligations for the commitment period for the commodity to be purchased. The central node 170 can automatically allocate the demand curve into settlement periods and billing periods.

The consumer node 112 has access to a database of end-use devices typically found in households via the central node 170. Intensity implies that an end-use device over a period will be operated for an estimated duration.

The consumer node 112 uses an abstraction approach to allow householders to identify the end-use devices that they have within their household. For example a Sanyo microwave EMS8000W is known as a microwave, then as a Sanyo microwave, a Sanyo microwave EMS, and finally by its model number. This abstraction approach allows consumers to pick end-use devices quickly and for consumer node 112 over time to infer or learn what the likely end-use device is. The end-use device details are stored by consumer node 112 and/or the central node 170 and are used to convey a standard consumption profile across all households.

It is envisioned that in the future devices with Zigbee or other such wireless or wired communication technologies will contain model identification within its embedded configuration simplifying the registration of devices by consumer node 112. An end-use device can be a circuit where a number of devices are attached.

In this embodiment all consumption end-use devices are classified by a unique classification code that enables each device to be placed into a mutually exclusive category known as “Household Function” or a service. This also applies to any management devices 115 within the Household. The initial household functions include:—heating, cooling, hot water, washing, drying, cooking, refrigeration, pool, lighting, media and entertainment, computing and communications, security, health. Where an end-use device could be classified into multiple household functions its prime role will be used. Each household function will be further broken up into end-use “device class”. For example the household function “washing” may have one or more “device classes” called front “loading washing machine” and “top loading washing machine”. A device class can only belong to one household function.

Once a device is assigned a household class it is automatically classified into a household function as each household class can only reference one household function. Each end-use device contains a default watts that it consumes, average operational time and watt-hours for the end-use device. It also contains energy efficiency ratings broken up into three savings categories “energy efficiency lifestyle” (EE-L), “energy efficiency” (EE-GB), and “load shifting” (EE-LS). Each end-use device savings category has an average expressed as a percentage and a standard deviation. As an example a 10% average energy efficiency means that the end-use device under system 100 can save 10% consumption through energy management without lifestyle impact.

Each end-use device is also assigned a default saturation % for that country or jurisdiction, being Australia in this embodiment. This end-use saturation rate is used to derive the number of end-use devices in Australia when it is multiplied against the total number of households. Saturation of end-use devices is determined from the end-use database. The jurisdiction is broken up into a number of ee-regions, each of which belongs to a single state or area. Each ee-region is mutually exclusive and it is expected that end-use devices operating within such region will consume power differently because of environmental factors. For example the same air conditioning unit will be operated longer in Brisbane's hot climate than in Hobart's cool climate. Therefore each end-use device is further broken down into an end-use device by ee-region. Further, all attributes that are sensitive to the region for end-use devices such as average operational time are defined. This enables a consumption and energy efficiency to be determined for the device. For example end-use device is different within a major city that it is for a regional area.

The consumer node 112 and/or the central node 170 have access to an extensive preloaded database of end-use devices and the capability exists for this database to be updated as new devices are introduced and as the device's operating characteristics are better understood. The end-use database is open and updateable by registered users in a manner that is manageable by the managing entity. The end-use module of system 100 has the capability of determining the saturation rate for each end-use device by ee-region and its respective energy consumption and efficiency. This information must be able to be consistently rolled up into states. For the purposes of system 100 each ee-region can only exist within one energy management region (for example the NEM).

The consumer node 112 and/or the central node 170 have access to the resource reticulation system within the area under management of the consumer node. This reticulation system defines the linkages and control mechanisms between devices to enable the consumer node to manage the consumption of resources.

The present embodiment further provides for household/consumer protection. Consumers purchase an end-use device 114 and rely on both the claims made by the manufacturer and heavily rely on the “label” affixed by a governmental agency, eg in Australia the “energy rating label”. Energy efficiency is undertaken in a test environment and rarely is there any policing of compliance to the label. It is possible that a manufacturing flaw, deception or a fault caused through operation changes the energy efficiency rating of an end-use device. Governmental agencies take seriously compliance issues and the result for suppliers can be the removal of the right to sell the product within the country. Therefore suppliers will be forced to engage with regulators for reaching an appropriate restitution when it becomes mandatory for consumer redress, environmental redress, and penalties (ie Australian Competition and Consumer Commission). Due to the lack of a capability to monitor household end-use devices cost effectively regulators (a) almost never independently verify manufacturers' claimed energy consumption or efficiency, (b) rarely penalize manufacturers for false claims or circumvention, and (c) substantiate that “tested operating characteristics” compare to use under real life conditions. Regulators police and enforce by complaints received by competitors or consumers or consumer advocacy groups.

Noting the issues set out in the preceding paragraph, the consumer node 112 and/or the central node 170 have the capability to assess operating capabilities of a nominated end-use sub-set to assess their energy efficiencies against their stated energy efficiencies. Where it is noticeable that the end-use device falls short the consumer node 112 is capable of notifying the householder so that they may take action. The consumer node 112 also provides data to assist them in the claim from the supplier, and also provide regulators with a feed of the suspect devices in particular categories. This service from consumer node 112 protects the consumer investment in end-use devices 114 ensuring that they achieve declared operating characteristics.

The consumer node 112 and/or the central node 170 have the capability to compare current in home devices with alternative devices in the end use device database. This allows the managing entity to provide efficiency benchmarks and return on investment based on a correlating price database. In addition the managing entity can facilitate commercial arrangements with Third Parties 173 for end use devices or services.

The consumer node also in the end-use device module has the capability to maintain household statistics projected into the future. Household information is further divided into ownership status of occupier (renter, owner, occupier) and owner occupier is further divided into mortgage status (mortgaged, non mortgaged) which further enables the consumer node 112 to determine energy efficiency potentiality for each ee-region and the ability to project forward into the future. Rental is divided into private ownership and other, where other reflects public or charitable housing. Households in system 100 are divided into three mutually exclusive consumption classifications by commodity type known as segments. Each consumption segment is asset class specific, that is, electricity, gas, water etc. For each consumer node 112 such statistics are obtained for that consumer site, while central node 170 may obtain such statistics for multiple consumer sites, whether on an individual level or averaged across a parcel of households.

For energy this is Large, Medium and Small which indicates the level of consumption for both gas and electricity. This may also be applied to water. This information is time sensitive and will change over a projected period.

A NMI is a unique meter identifier used within the NEM. Other identifiers will be used with other consumables in other markets. In this embodiment there is a distinction between a NMI and a household. A household is a unique dwelling that is the basic area for which the managing entity undertakes energy management services. It is possible that a household has more than one metering point, therefore more than one NMI, but it is not possible that a NMI can belong to more than one household at the same time. A customer is a role that an entity assumes who has the financial relationship over a household and the managing entity. A customer may have several households they have obligations for. If a customer is a natural person (other than a legal entity) the customer may reside in a primary household and over time reside in many.

System 100 has the capability to assemble a history of households that a customer has been associated with as a resident to be able to establish consumption histories. Therefore when a customer is joining system 100 and provides metering identification (NMI) information, it is possible that they provide one or more identifications (NMIs) in time and that these may overlap. It is possible that some are for the same asset class or that they are all of different asset classes. The central node 170 as it constructs this database uses the knowledge of who was in possession of which metering point (NMI) to assist in further validating other customers. The consumer node 112 automatically determines the consumption segment for a household 110 based on the residence of the customer.

Each ee-region has an allocated carbon intensity for electricity consumed within the ee region. This carbon intensity is used to calculate the carbon emission associated with electricity consumption within the region. For example an intensity of 1.05 means that for every one MWh consumed 1.05 tones of CO₂ equivalents are deemed to have been emitted. The carbon intensities are published by region by the electricity market operator or other agency. In Australia this is the NEM.

The managing entity through energy plans with householders charges for electricity using a flat rate for committed volume, electrical consumption, within a given band around a baseline with some flexibility for variation (a plus/minus a specified tolerance). If electrical consumption exceeds a predetermined upper threshold, a surcharge is levied to the consumer. Should electrical consumption be less than a baseline threshold the consumer may sell “excess” back to the managing entity for their advantage. The surcharge is levied by the central node 170 because it provides an incentive for consumers to take responsibility in predicting their future energy needs. Also a surcharge encourages energy efficient behaviour at the household level. The surcharge also exists to cater for the fact that central node 170 has to acquire further power to meet those periods when householder's consumption exceeds their commitments.

When a householder requires more energy above their baseline this is referred to as a top-up. The surcharge only applies when it exceeds the upper threshold band. For example if the energy plan's baseline is for 10 MWh for a year with a predetermined upper threshold of 1 MWh, a swing in the SOBA, in the situation where a consumer requires an additional 2 MWh above their baseline (10 MWh) they will be levied a surcharge over the 1 MWh.

The managing entity provides householders with the consumer node 112. This device has energy management capabilities. Node 112 monitors power consumption within a consumer's household 110 and manages all controllable power consuming loads to enable a householder to benefit. This may involve a strategy where power consumption is maintained to or below a predetermined run-rate.

An important aspect of the consumer node 112 is that it monitors a consumer's electrical consumption for the period by tracking their actual usage-rate against the planned rate and where the consumer node 112 determines that the forecast is likely to exceed the upper threshold the consumer node 112 takes corrective action. This corrective action is within the instructions stipulated by the householder. A corrective action could be to secure additional energy.

The consumer node 112 has a list of preset prioritized loads that can be dropped in an order of precedence where a load having the lowest order of priority will be closed down initially and the load having highest priority order will be closed down only after everything else has been shutdown. The consumer node 112 brings these loads back on stream in the opposite, or reverse order, that is loads with the highest priority that are offline are switched on-stream before others of a lesser priority. The consumer node 112 further allows for loads which are critical to safety and security and those which are associated with lifestyle. Moreover, the central node 170 coordinates the plurality of consumer nodes 112 to ensure that consumers' devices are reactivated in a staged manner to minimise disruption to the electricity grid or network, as might be caused by a large number of devices being simultaneously activated.

At set-up the consumer selects threshold bands at which it would like energy curtailment to cut in and the pre-conditions when this is to be implemented by consumer node 112. Consumer node 112 is designed to gracefully drop loads as power consumption approaches these predetermined band thresholds, or target levels. Those previously dropped loads can be brought back on-stream within the household as power consumption begins to descend from this target back to a normal planned rate. When the electrical power consumption is forecast to reach a predetermined threshold, consumer node 112 initiates execution of its set-and-forget strategy of reducing consumption of electrical loads, as programmed by the householder. Consumer node 112 continues this dampening of consumption until consumption is forecast to reduce below the threshold within a certain timeframe.

The energy management strategy of consumer node 112 is to reduce energy consumption within a period and this is implemented with safeguards to ensure that health, safety and lifestyle policies are adhered to. These policies are preset by the managing entity, and further refined and controlled by the householder via a portal. For example consumer node 112 monitors wireless temperature probes embedded within freezers and fridges to ensure that food items are not spoilt whenever power is closed to these devices. And if consumer node 112 approximates that foodstuffs may have been spoilt (due to power shutdown, or outage) it will issue a warning to the householder.

Lifestyle policies centre around comfort in the household environment and include lighting, humidity and temperature. As a policy the householder nominates the priority and consumer node 112 implements this directive. Security can also relate to alarm systems, health monitors, and external lighting.

Another important aspect of system 100 is that it provides the environment to enable a householder and/or retailer to monetize peaking in electricity prices (in the pool market) during periods of high demand. This monetization is effected by automatically implementing an ordered curtailment strategy to exploit such prices. As part of the energy plan a householder and the managing entity agree on a profit sharing arrangement for exploiting high energy prices. At set-up the householder stipulates their preference for the scale of curtailment. This specifies the amount of load-shedding that the consumer would prefer under certain conditions. For example going “black” means that all power except for some minimal lighting (during night) is shed whereas going “brown” means that only loads nominated as essential are kept operating. Going “white” is that no curtailment is undertaken. This arrangement will also apply with Distributors 175 to optimise their infrastructure. A Distributor can proactively manage their infrastructure based on real time household usage. This is achieved through a network connection and communication between the central node 170 and the Distributor 175. For example, a Distributor 175 can now enact maintenance by shifting energy distribution based on the information contained within the consumer node 112 and/or central node 170 or implement curtailment. Further still the consumer node 112 can shift consumption to alternative means to leverage peak pricing or to enact curtailment without the loss of energy supply to end use devices 114. This can include, but is not limited to, Distributed Generation Devices 119 such as Solar, Electricity Storage Devices, or Fuel Cells 118 or other consumables. The consumer node 112 can also facilitate energy supply back into an electricity grid via a Grid Interface Device 120.

The central node 170 at all times understands its capacity to undertake curtailment by polling all households with operational consumer nodes 112, so that central node 170 can establish the amount of energy it can sell-back to bilateral parties. This is the sum of normal sellback pools and the extra energy that can be curtailed. Once the central node 170 implements curtailment this is an automated process between the central node 170 and all participating consumer nodes 112 within a nominated energy area for a nominated amount of energy over a nominated timeframe. Each consumer node 112 has a Curtailment Management System embedded within it to undertake curtailment as and when required.

Force majeure conditions may dictate that energy is cut from the household or that governmental authorities or the energy market regulator may initiate measures to undertake a forced curtailment. Under a forced curtailment the consumer node 112 still provides for minimal operation when compared to a household without such a consumer node 112.

The consumer node 112 has the capability to monitor the status of electrical power supply and provides constant feedback of power quality to central node 170. In additional to normal monitoring, the consumer node 112 will have the capability to wirelessly network temporary specialized electrical power monitors (located at the household) to monitor power quality, log momentary disruptions, and other quality of service issues to enable the central node to responsively and objectively resolve customer complaints centering on quality of power supplies. As these devices are typically expensive and temporarily installed, they are a tracked asset from an asset register perspective and originate from third parties.

Consumer node 112 has the capability to readily detect a variety of impending power failures by monitoring such quality monitoring devices and when power failures do occur the central node's capabilities enable it to comprehend the magnitude in terms of householders affected and its geographic coverage. This information will be automatically conveyed to the respective networks' managing supply.

Outages are made publicly available on a website of central node 170 and consumers will be able to visualize the extent of outage. The central node 170 provides via a website giving quality of service information about the electrical power service they are connected to and identify responsible providers (those who own these assets).

The consumer node 112 has the capability to notify central node 170 that power supplies are not reaching the household 110, for example due to a local problem (eg tree fallen over powerlines). This in turn enables the central node 170 to automatically notify the appropriate network operator that there is a potential problem in their local grid and to provide information which areas are affected. This in turn enables network operators to have immediate visibility of locations cut from the grid and in their problem analysis.

This automated notification further allows central node 170 to avoid a surge in the relevant contact centre by automatically notifying householder 110 via mobile phone SMS or comparable messaging service (e.g. email, or twitter type message) or messaging to the consumer node 112 that it has recognized the serious issue and will provide an estimate when the power service will resume.

Where end-use devices 114 have the capability to issue notices on functioning status, for example impending failure (eg due to intermittent fault), the consumer node 112 has the capability to issue emails to householders to relay such messages.

The central node 170 maintains a position forecast for the weather projected into the future (up to two years) by region by day and with associated probabilities known as a “weather outlook”. Also in the weather outlook is the Heating Degree Days (HDD) or Cooling Degree Days (CDD) for each day. The weather outlook is the reference model used by central node 170 in taking positions and determining consumption (related to weather). Therefore it is necessary to update any energy load demand curves whenever the weather outlook model is updated.

The consumer node 112 logs measurement of consumption within a household 110 and consumer node 112 constructs a model that forecasts energy load demands at the household level. Conventional forecasting approaches are not practical when forecasting energy loads for a large population of households because they are not capable of responding to the needs for recalculation caused by ever-changing conditions. Conventional household forecasting usually requires centralized processing of massive volumes of data employing linear regression algorithms and considerable windows for undertaking these calculations. This presents a problem in obtaining the information on a timely basis and to calibrate the models to changing household characteristics, household operations and environment. In system 100 this function is decentralised to the consumer node 112 embedded within the household 110. This removes data traffic issues, isolates errors in forecasts to a household level, and removes issues around processing vast amounts of data centrally. It also deals with privacy concerns about the delicate issue of access to private household information.

The consumer node 112 collects and stores energy consumption information locally at a household level. It also has the capability of running energy load forecasting algorithms embedded within the consumer node 112. These algorithms use this historical consumption data and other information, such as weather outlook, calendars and profiles. Consumption data based on end-use devices is measured at intervals that are defined at setup. These settings can be changed at anytime by an authorized householder.

The consumer node 112 frequently obtains observations and weather outlook from central node 170. Some consumer node systems, being those with associated climate sensor type management devices 115, have access to temperature information external to the household from household sensors connected directly to the consumer node 112 home wireless network. Energy forecasting system for consumer node 112 operates regularly and relates a number of coefficients factors with energy consumption. The system is designed to improve and evolve in its forecasting ability. Once the household model is provided a number of forecast parameters it is able to determine the likely energy load required. These parameters are related to household coefficients that are initially provided by central node 170. They are based on an assessment of the profile of the household 110 and are automatically adjusted over time to reflect learning by the consumer node 112.

Central node 170 also has access to these coefficients for the household to assist in portfolio and risk management. Consumer node 112 uses actual observations to update its weather outlook for the day to enable it to better forecast energy loads.

Weather risk management aims to achieve financial protection from weather conditions that adversely affect earnings for central node 170 and may cause financial impact to householders. Weather risk is about “weather surprises” the unpredictable element of weather fluctuations that impact financial performance. To assess the risk potential for “weather surprises”, and to also prepare the appropriate hedging strategies, the central node 170 determines how much weather noise exists that needs to be managed or eliminated. Therefore the central node 170 requires a weather model that encompasses weather noise to be able to forecast weather risk.

Weather agencies (such as the Australian Bureau of Meteorology) use structural models to forecast weather over the short-term focussing on atmospherics. However central node 170 does not require such a complex and elaborate structural model. Central node 170 uses a time series approach in its weather outlook.

In addition to the use of SOBA to manage volume fluctuations central node 170 may use weather derivatives to further protect the managing entity's exposure to movements in volume (outside the SOBA thresholds) against weather risk brought about by unusual winters or unusual summers. In some situations the managing entity may have financial exposure to unexpected variation in weather conditions specifically in cases where this causes the volume underwritten by SOBA to either exceed the whole of company upper or lower SOBA thresholds. As the average pool price tends to hover around a long term mean ($70/MWh) the key risk that the managing entity would seek to address is protection against unexpected extremely hot days or cold days when demand for energy can outstrip available supply and force the central node 170 into the pool market to purchase energy whilst prices are peaking (eg when reaching a Market Price Cap (formerly known as a Value of Lost Load (VoLL) event) in the NEM in Australia, being an event where the maximum cap for the pool market spot price has been reached).

Conversely the central node 170 may also seek to protect against lower consumption caused by unexpected weather. For example in summer, central node 170 may seek to protect against cooler (than normal) temperatures, which reduce the volume of electricity consumed. On the other hand, in winter the central node 170 may seek protection against warmer (than normal) temperatures that will also reduce the volume of energy consumed.

Weather derivatives provide a useful tool for central node 170 to hedge against such weather risk. Weather derivatives are designed to absorb a portion of weather risk exposure, leaving a residual risk that is acceptable with the managing entity's risk policies. As weather derivatives can be used to hedge weather risk in other sectors these sectors will have companies that are candidates to become counter-parties to the derivative contract. Therefore the central node 170 manages this class of derivative.

The consumer node 112 has the capability to manage load-shifting for end-use devices 114 and end-use circuits that it can control. This enables consumer node 112 to activate and deactivate such devices accordingly. The consumer node 112 load shifting strategy is set-up by the consumer via a portal service that is accessible via the internet or directly on the node 112.

A further advantage of system 100 is that central node 170 can improve its energy buying through the additional information that consumer node 112 provides, by being able to understand consumer consumption as well as being able to monitor this in near real-time enabling improved buying in energy and reduction in associated risks. Moreover:—
Where basic meters are currently installed in households consumer node 112 enables central node 170 to move away from wholesale settlement using Net System Load Profiles (NSLP as known in NEM Australia) to using consumption information provided by consumer node 112 via an installed smart-meter (described further in the following);
Improved buying of electricity due to improved certainty of volumes brought about by customer energy plans requiring fixed energy obligations with flex; and
Improved buying by improved understanding of demand profiles of customers, as consumer node 112 will capture information on key end-use energy consumption devices within the household as well as the actual profile of energy usage (as recorded) by smart-meter.

This information is available to the central node 170 in near real-time and is an important input for load forecasting, marketing and demand side management. Such additional information, not available to conventional retailers (until smart metering is deployed and only a total household view) as provided by the consumer node 112's Demand Analysis feature becomes very important for estimating end-use energy consumption.

For each end-use device within a household, an approximate load factor can be estimated. This approximation can take into consideration variation in the load over the course of a day, the impact of anticipated CDD or HDD, and provides insight into what is driving the peak load for that household. The consumer node 112 demand analysis model draws on smart metering data combined with weather observations and customer (device) data in a multivariate regression framework. The basic idea underlying the customer demand analysis concept of consumer node 112 is that the total load can be disaggregated into the component or end-use loads. These in turn can be modelled using thermodynamic principles as appropriate. The consumer node 112 Demand Analysis has advantages over simply exclusively using end-use metering in that usage can be directly related to end-use devices. By purchasing electricity using SOBA and selling retail electricity to retail customers, the managing entity is exposed to a commodity price risk exposure equal to the difference between its purchase price for electricity from the SOBA, and its sale price to its retail customers under energy plans. The risk exposure is present in volume changes above thresholds in SOBA as well. Consumer node 112 customers purchase energy using energy plans. This requires the customer to purchase fixed energy. Being able to predict with greater certainty energy usage the managing entity (retailer) is better positioned to improve their negotiation for energy buying and hedging.

It is to be appreciated that the consumer node 112 also enables the central node 170 to move away from Net System Load Profile (NSLP) Wholesale Model (in the NEM, Australia) to actual usage metered in real-time. This enables the central node 170 to manage volume risk during peak and off-peak periods in an energy contract. The consumer node 112, being able to meter consumption in near real-time, enables central node 170 to move away from using the NEM net system load profile (NSLP) and as such provides the opportunity to exploit discrepancies between profile and actual usage as well as to monitor risk exposures (volumes and price).

Demand management employs a bottom-up predictive approach whereby all end-use devices' consumption and production within the household are assessed against weather outlook, residency patterns, calendar (holidays, weekdays etc) and known events. Demand management also has the capability to store historical information on end-use devices and resource consumption and production for an extensive period. This residential micro-data is kept private at the consumer's discretion. Demand Formulae are constantly evolved within this service and are used to predict demand for each resource by time period by day. Forecasts are projected 24 months into the future on a rolling basis.

The household's data is owned by the customer and is fully controlled by the consumer node 112 that grants rights to access and use this data. The consumer node 112 regularly undertakes offsite backup of the data within consumer node 112 and has the capabilities to restore remotely backup data when required for example after a hardware fault has been repaired.

The householder has extensive control of the consumer node 112, and the consumer node 112 will behave according to the policies laid down by the householder.

The present embodiment of the invention thus recognises that shifting wholesale price risk to the consumer reduces electricity charges to consumers. It is an intention of this embodiment of the invention to provide a mechanism of countervailing market power in electricity pool markets by enabling retail consumers to profitably respond in real time to pool prices, by providing the consumer with access to electricity derivatives and giving the consumer the ability to sell their excess electricity commitments contained within these derivatives back into the pool market.

To enable residential electricity consumers to acquire electricity derivatives the present embodiment of the invention provides a method and system of aggregating many small energy future purchases by consumers into a single futures contract that is traded at a wholesale level on a futures or over the counter (OTC) market, whilst monitoring and reconciling the consumers' respective electricity consumption in near real-time at a residential household or business level. The present embodiment of the invention further provides effective risk management and straight through processing for counterparties and reduces operational risk, in an automated process that links an electronic OTC market, an electronic futures exchange and the aggregation system, to automatically generate a net position.

The present embodiment further recognises the need for a system that reduces operational risk for counterparties and provides near immediate straight through processing into back office and risk management systems. Hence, the present embodiment provides for retail electricity derivative contracts that allow a plurality of retail electricity consumers to hedge the risks of their electricity consumption, and provides these consumers with an electronic and commercial system that rewards them for using less than their electricity commitments within their electricity derivative, that is to gain benefit from increases in the pool price, reduction in their net consumption or improvement in their energy efficiency.

The present embodiment of the invention recognises that a major impediment to retail derivative contracts is the cost associated with pooling a large number of retail contracts (aggregation) including the costs associated with the risk, credit and revenue management. The present embodiment of the invention further recognises that another major impediment is the need to settle physical delivery of electricity in near real-time, that is to monitor and reconcile in near real-time the consumption of electricity across this plurality of retail customers netting against this consumption against the derivative contract at the retail household level. Retail electricity derivative contracts are structured in this embodiment in a manner that a consumer can more confidently, easily and cost effectively buy electricity using such approach than they would by using a more conventional electricity retail approach.

Hence, the present embodiment provides for such an independent retail electricity derivative contract and a supporting system for such contracts. The present embodiment provides a commercially viable market in retail electricity derivative contracts wherein household retail energy consumers can buy electricity derivatives and sell excess energy commitments (electricity not consumed) whilst understanding their current position and likely future position in terms of energy consumption.

Although it has previously been possible for consumers to be informed of the wholesale pool price in near real-time, the benefit of any potential saving, if any, will seldom exceed the cost in terms of vigilance, time and effort. The present embodiment of the invention recognises that a need exists to manage all this complexity at a cost that the consumer would find beneficial and of utility. Residential and business consumers also would consider the price risk from volatile pool prices as being significantly higher than their willingness to accept that risk, especially without easy access to price information and their unwillingness to be economically compelled to forgo energy usage for extended periods when prices are high.

This embodiment of the invention thus enables consumers to access substantial financial rewards by providing a mechanism to exploit the incidence of high prices in the pool market by being able to curtail or reduce electricity consumption, in a manner that a practitioner in the art would readily understand as being aggregated demand side response and the ability to generate sellback of unused energy.

The importance of this aspect of this embodiment of the invention is that it delivers an effective capability to effect demand side response in a pool market by aggregation of a large number of residential consumers. This embodiment of that invention also provides consumers with enhanced value through superior buying power due to its ability to aggregate consumer future electricity loads into composite pools that can be used to purchase large futures contracts and beneficial prices that only emerge with scale.

This embodiment of the invention enables a retailer model that reduces the price of electricity to consumers, encourages the consumer to become energy efficient whilst increasing the profit to the retailer. There is a need for an alternative electricity retail model where the price of electricity is the summation of all the costs and instead of ad-valorem profit added to this cost base a fixed transaction fee charged to cover the profit.

This invention would provide the environment that would foster an alternative retail electricity model where retail prices are set on a cost-plus fixed-profit basis. Such a model will benefit both the retailer and the consumer. It benefits the retailer because the cost of selling different volumes of electricity would incur the same direct costs. For example, apart from the electricity cost, selling a consumer $800 worth of electricity is the same as selling $4000 worth of electricity to another consumer. Therefore such a model would mean that a retailer would be able to ascertain with a high degree of certainty their profit on the sale of an electricity contract to a consumer. Such a retail model will provide transparency on all costs and ensure that the retailer with the most efficient operation will deliver the lowest price electricity to the retail customer. Such a retail model will see that the retailer who can secure the best forward derivative, that is the lowest wholesale electricity price, will stand to prosper in a competitive deregulated market.

From a consumer's point of buying electricity whereby the wholesale price risk is managed by them and the final price is cost-plus fixed profit margin materially reduces the price paid when compared to the conventional cost-plus and ad-valorem profit model.

A retail consumer that has purchased energy where they have also hedged against price risk will need to be vigilant to a greater or lesser extent, to ensure that their consumption position and financial position are suitably managed. Any excess electricity that a consumer may have whilst under a hedged contract for electricity can be on sold. This allows the consumer to gain from energy efficiency and to also gain from the price in the wholesale pool market.

The present embodiment of the invention thus recognises that there is a need to be able to secure excess electricity for a particular period at a retail consumer level and aggregate this excess across the total consumer base of a retailer and exploit this on the pool market either through the use of derivatives or through consumers that need to secure additional energy in near real time. The present embodiment further recognises that, having taken benefit of this excess, there is a need for the retailer to be able to share the value so secured with consumers in a manner that is commercially flexible recognizing consumer contribution and other financial obligation arrangements by the consumer.

The present embodiment of the invention further recognises that to fully benefit from a retail hedge requires home integrated energy management, interworking of devices, and an energy plan that provides the commercial structure to monetize gains. A retail consumer currently is unable to manage their respective electricity consumption manually to warrant the investment of time and vigilance required. Therefore a need exists to have this energy efficiency managed by an automated agent acting on behalf of the interest of the retail consumer in a manner that preserves their privacy and financial position.

The present embodiment further recognises that a need exists for a retail consumer to advise this agent (the consumer node 112) of its electricity consumption, risk and financial policy and delegate mundane and time consuming vigilance to this agent that will work towards satisfying the energy needs of the retail consumer. This agent needs to be able to understand future energy demands of the retail consumer and provide for this accordingly whilst achieving said policies laid down by the retail customer in the interest of the customer.

This embodiment of the invention further recognises that to monetize opportunities at a retail consumer level a commercial structure must exist between the retail consumer and the retailer. This commercial structure must define value sharing and define how the electricity service will be charged for as well the commercial basis for provision of said infrastructure at the retail consumer's location. This commercial relationship is an energy plan and a need also exists to ensure that the agent and retailer actions reflect this plan. Therefore a need exists in aggregation of small future residential contracts into a pool which is then used to acquire one or more large futures contracts requires a method and system to manage financial, credit and operational risk to provide counter parties with assurance of contract performance.

The present embodiment provides the mechanism for effectively monetising significant spikes in the wholesale price cost. It is notable that derivatives distribute the effects of spikes out over the term of the derivative through averaging such spikes, whereas this present embodiment enables capacity created by demand management or capacity to be sold at spike prices creating value during these spike events.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

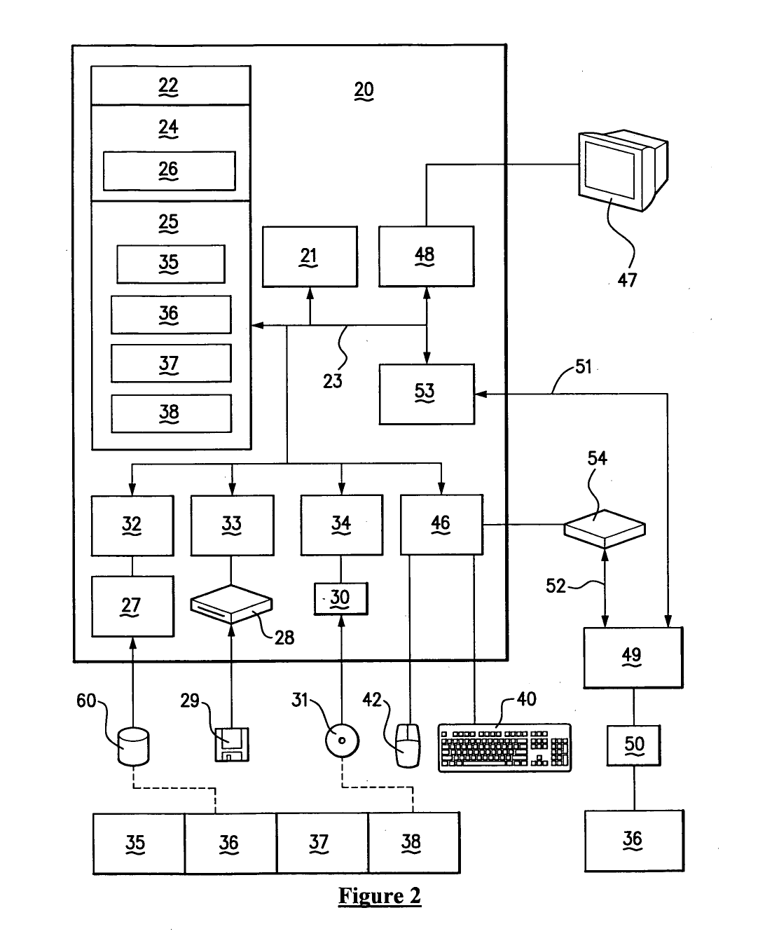

Turning to FIG. 2, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

In FIG. 2 a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk or solid state drive 27, magnetic disk drive 28, and optical disk drive 30 are connected to the system bus 23 by a hard disk drive interface 32, a magnetic disk drive interface 33, and an optical disk drive interface 34, respectively or general IO (input/output) interface. The drives and their associated computer-readable media provide nonvolatile storage of computer readable instructions, data structures, program modules and other data for the personal computer 20. Although the exemplary environment shown employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated. The logical connections depicted include a local area network (LAN) 51 and a wide area network (WAN) 52. Such networking environments are commonplace in offices, enterprise-wide computer networks, intranets and, inter alia, the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

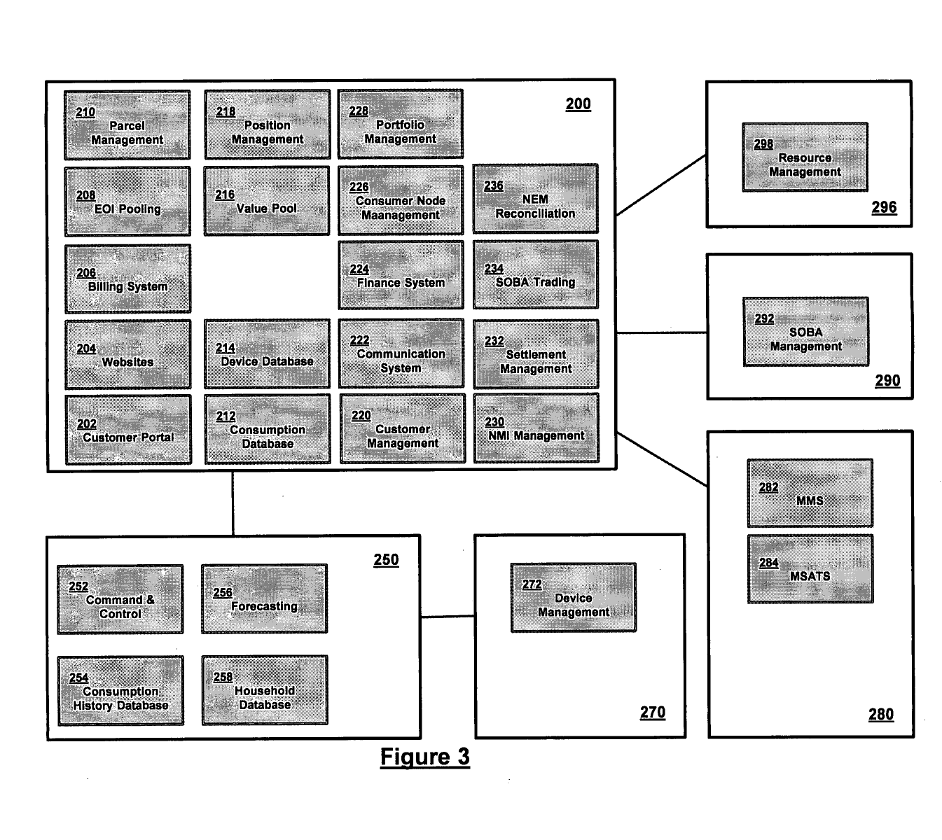

FIG. 3 illustrates the system architecture of elements making up the electricity supply management system in accordance with FIG. 1, and further illustrates software modules executed by each element to effect operation of the system. The software modules perform the operations, processes and mechanisms of this embodiment of the invention. As will be appreciated some of these systems can be further broken up into constituent parts. The software modules of FIG. 3 will reside on respective physical hardware such as by being stored on a computer or server's hard disk drive. To operate, each module's components are loaded into RAM and instructions processed via a CPU.

As shown in FIG. 3, the software resides and is executed in a number of different locations and facilities. The Retailer hardware and facilities 200 is typically hosted on the internet and each solution is accessible by the customer or software in other facilities via the internet. Facility 200 requires one or more servers, network switches, firewalls, routers, cables, and storage devices (not shown) to manage the software modules 202-236 of this embodiment.

The consumer node 250 carries software 252-258 which is installed onto the physical smart box (112 in FIG. 1). The software of node 250 can interface with the central software of node 200 through an internet connection in the household.

Node 270 represents household devices (see 114 to 120 in FIG. 1). Software module 272 may be installed onto each device operated within the household. This software 272 may be supplied solely by the manufacturer of the device with a standard software protocol such as ZigBee to communicate with the consumer node 250, or may contain additional software based on the requirements of the invention.

Node 290 represents the Generator hardware and facilities (see 174 in FIG. 1). Software module 292 is installed onto servers and computers operated by or on behalf of the Generator.

Node 296 represents Distributor hardware and facilities (175 in FIG. 1). Software module 298 is installed onto servers and computers operated by or on behalf of the distributor.

Node 280 represents Market regulator hardware and facilities (171 in FIG. 1). Software modules 282-284, as found in AEMO in Australia, are owned and operated by the market regulator and interface with the computer programs of node 200 to facilitate household or market data sharing and financial transactions.

In FIG. 3, each facility and its hardware is connected to the internet or local area network so that information can be transferred between the different nodes. Such connections may require the hardware such as wireless radio, switches, routers, modems, and network cables. These connections are secured through either a virtual private network or suitable method of data encryption.

In addition to the computer programs in FIG. 3, additional software is required to support the invention software. This will include computer and server operating systems, application programming interfaces, database management software, communication protocols and security software. This software is generally provided by third party providers and can be shipped with the hardware.

The computer programs within the household are executed by either the smart energy box 250 or the individual devices 270. Command and control software 252 sends and receives instructions and information from these devices. Depending on the device, this information can be temperature related, the energy consumption of the device in real terms, status as to whether on, off or in standby or the flow of the resource. The collection of this information occurs first by way of the physical characteristics of the device 270 such as a thermostat or electrical circuitry. Software in the device 272 determines when and how much information to collect and send, and when to execute a mechanical change of its physical characteristics such as to turn on or off.

The parameters controlling software 272 are sent from 252 which will be defined routines or user driven. Defined routines are preconfigured instructions which execute based on a set of conditions determined by the company. For example, device information will be sampled every minute and stored on node 250. Defined routines also include the logic on how to communicate with each device. User driven routines are based on parameters set by the customer. For example, a user may wish to turn off a device immediately, or at a determined later time. Node 250 can also maintain a set temperature within the house by communicating on/off signals to an air conditioner. User driven commands are obtained through a user interface which will reside on either central system 200 or on the consumer node 250. When provided on the central system 200 the user interface will take the form of a customer web portal 202.

The control software 252 is also capable of load shifting a device in that it will turn on and consume at a point in time. This is usually done so that the device completes its service at a time when the wholesale price of the resource or its tariff is cheaper. As an example a dish washer can be programmed to turn on to wash dishes when there is an off peak tariff.

Information sent back from 272 is stored on 250 in a database 254. Information that relates to the consumption of a resource such as watts, joules or litres used is stored in consumption database 254. The consumption database is historic in nature and contains consumption at a point in time. Each point in time therefore refers to an aggregation of consumption from a previous point in time. A device 270 may also be a smart meter and the consumption data it collects is a total aggregate of the household and not of each individual appliance. The consumption data from a smart meter is required for customer billing and is treated separately. Depending on regulatory requirements it is envisaged that this data would also be stored on the smart box 250.

If the information is related to the status of a device or its characteristics, this is stored in the household database 258. The household database 258 also stores information set by the customer including environmental settings such as temperature, timed events to turn on/off end use device and customer preferences over the data including which data to share with the Retailer. A computer program 256 is responsible for forecasting consumption based on the historical data collected 254. It will be able to trend data into the future to determine whether a household will be on track against the purchased retail plan or will be below or above the planned consumption quantity. This future position is the dead reckoned position for the household and has a probability associated with it. As the consumption database grows, and knowledge of the consumer behaviour and lifestyle emerge the ability to forecast improves. Based on this information a standard deviation can be formulated to understand probable variance. This data is aggregated across a multitude of households to a central consumption database 212 and is used by the Retailer to understand the position of all its energy plans and associated probabilities across geographic and demographic regions and at future time intervals through another program 218. The forecasting program 256 is complemented with additional data such as weather forecasts as consumption correlates with weather to further increase the accuracy of consumption forecasts.

The retailer requires information from the consumer 250 to effectively manage the customer, its retail operations and perform this embodiment of the invention. This is achieved through a number of computer programs 202-236. The retailer will have websites 204 that position its brand online, market its services, perform its operations and provide an electronic method to engage and communicate with customers. The website will provide generic information that is applicable to potential and existing customers.

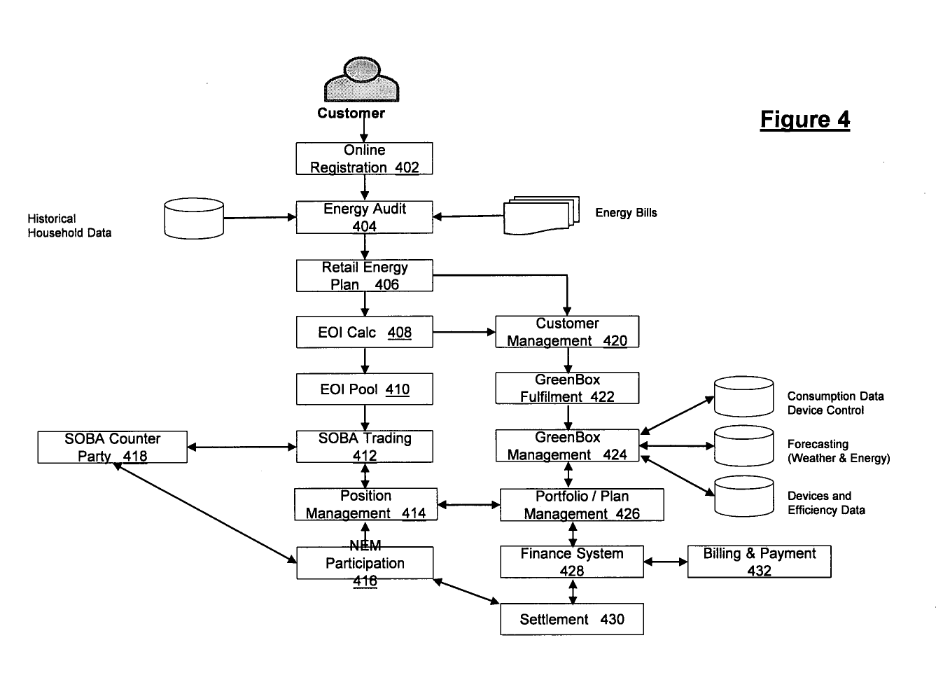

The website will allow new customers to register and purchase a resource plan through customer management software 222. When a customer registers, such as by the online registration step 402 of FIG. 4, a computer program on the website 204 determines the customer's efficiency potentiality by conducting an energy audit 404. This is important in forecasting demand for the purposes of this invention. This is therefore based on previous consumption data which is either entered directly by the customer through the portal 202 (for example previous bills) or automatically via NMI management software 230 in the current embodiment. The NMI management software can source previous household consumption from the Market Settlements and Transfer Solutions (MSATS) database 284 operated by AEMO 280. AEMO 280 also provides the Market Management System (MMS) 282.

Financial details on the plan and provisioning of the consumer node 250 to the customer are then handled by the Finance system 224. The proposed plan 406, called an expression of interest (EOI), is handled by another program 208 that pools all current customer EOIs (410) to evaluate suitability and determine geographic supply region and elements that make up a parcel for a SOBA. Once determined, the order is committed to the finance system 224 for final processing, and confirmation is supplied to the customer through the portal 202 or communication system 222.

The committed EOIs are grouped into parcels 410 by the parcel management software 210. These parcels are collated and supplied (412) to the SOBA trading software 234 to create a SOBA over the counter with a generator. It is intended that this be performed electronically in substantially real time based on pre defined conditions and rules maintained by SOBA software 234 and 298 between the retailer and generator respectively. The financial transactions associated with the SOBA and wholesale resource market are handled by the financial system 224 (428) and settlement management 232 (430). In this embodiment settlement software 232 manages payment (432) and prudential requirements of AEMO in conjunction with the finance system 224. Customer billing and payment (432) for resource consumption is managed by the Billing System 206 online via the customer portal 202 and billing notification may also be provided through the communication system 222.

The charges arising from the wholesale market are reconciled against customer consumption by the NEM reconciliation system 236 so that demand and supply are exact, and so that a true account of the finances are provided.

Specific information relevant to each customer will be delivered through a customer portal 202. This will allow the customer to manage their household data and devices through a user interface that communicates with software on the consumer node 250. Consumption data will be presented to the customer in such a way that they understand how resources are being consumed within the household, down to individual devices and appliances. Providing this information will assist in behavioural change and attitude towards consumption and provide a greater and even automated control of devices and appliances within the household. This in turn should enable the customer to become more efficient with the use of the resource or alternatively shift the use to a time where market pricing of the resource is lower. In both respects this will assist the customer in reducing their bill. More importantly this creates capacity within a retail plan which can be leveraged through this invention to sell current or future unused resource consumption back to the generator or other market participants at a price. Furthermore, it is an aspect of this invention that a mechanism will allow for a transfer of a quantity of a SOBA to be transferred to another party (418) to facilitate this transaction. A customer can enable the buyback of unused quantities of their plan through the customer portal 202.

To assist in achieving efficiency a Device database 214 provides comparative resource performance against the devices within the household so that the consumer can benchmark their end use devices and make an informed decision as to whether to upgrade. It also ensures that the quoted performance characteristics of a device are being achieved in actual operation. This is a further unique aspect of the invention wherein the customer can receive a self audit of their end use devices as to their compliance towards regulatory standards or manufacturer representations.

There may be circumstances where a generator or distributor requests a collection of households to curtail their demand of a resource. As example where a distributor may need to perform maintenance or where overall demand is reaching a peak threshold for supply. A customer may agree to such request through the customer portal 202 or in return to a method of communication such as SMS of Email through software solution 222.

All existing retail plans and their corresponding SOBA are managed by the Portfolio management software 228 (426) for the life of the plan or contract. This software keeps track of all consumption to date against each plan and other details such as the price of resource purchased, if the household plan is part of a community plan, any resource top ups and the expiration date of each SOBA and retail plan. It can also issue customer reminders (420) when the plan is near completion through the communication system 222 or customer portal 202.

The dead reckoned position of each household, SOBA, region and total customer base is formulated by the position management software 218. This software through its algorithms and all data at its disposal can create a position for the company on whether to maintain existing SOBA quantities or enact a swing to increase or reduce resource quantities within the parameters defined by each SOBA. It will formulate short term and long term positions and will interface with the household forecasting system 256 to ensure that a household plan will balance based on customer preferences, consumption and market positions of the company.

If the customer has agreed to participate in specific energy management activities such as curtailing demand or achieving a level of energy efficiency then they can be rewarded for this. This can be achieved at a household level or within a community or family group. The management and apportion of these rewards are performed by a Value Pool program 216.

It will be appreciated by persons skilled in the art that numerous variations and/or modifications may be made to the invention as shown in the specific embodiments without departing from the spirit or scope of the invention as broadly described. For example, the consumer node 112 may in other embodiments be connected other than wirelessly to end use devices 114, such as by twisted pair wire, Ethernet, power line communications or optical fibre, C-Bus, or any other suitable wired network arrangement. Network interface 118, while shown separate to device 112, may instead be an internal network interface contained within device 112. The present embodiments are, therefore, to be considered in all respects as illustrative and not restrictive.

1. A system for efficient consumption of a consumable, the system comprising:
a plurality of consumer nodes each associated with a respective consumer site, each consumer node for gathering consumption data from one or more consumer devices consuming the consumable; and
a central node in communication with the consumer nodes, for determining a collective consumption of the consumable across the plurality of consumer sites, for participating in live markets in order to secure delivery of the consumable as required collectively across the plurality of consumer sites, and for communicating market data conveying substantially live market effects to the consumer nodes;
wherein the consumer nodes are operable to process said market data in a manner to influence consumption of the consumable.

2. The system of claim 1, wherein the consumption data gathered from the one or more consumer devices comprises data reflecting a subset of consumption of the consumer site being consumption of one of a plurality of power circuits within the site.

3. The system of claim 1, wherein the consumption data gathered from the one or more consumer devices comprises data reflecting consumption of one or more elements within the site.

4. The system of claim 1, wherein the consumption data reflects an instantaneous rate of consumption.

5. The system of claim 1, wherein the consumption data reflects cumulative consumption for a period of interest.

6. The system of claim 1, wherein at least one consumer node is configured to gather the consumption data by wireless communication.

7. A consumer node for facilitating efficient consumption of a consumable, the consumer node being associated with a consumer site and being operable to collate consumption data gathered from one or more consumer devices consuming the consumable and communicating collated consumption data to a central node for use in collective market participation, the consumer node further being operable to receive from the central node market data conveying substantially live market effects and to process said market data in a manner to influence consumption of the consumable.

8. The consumer node of claim 7, comprising a display means to display the market data for viewing by persons at the consumer site, such that those persons may take market conditions into account in deciding how to consume the consumable.

9. The consumer node of claim 7, wherein the consumer node is operable to use the market data to control the operation of at least one consumer device in response thereto.

10. The consumer node of claim 7, comprising input means by which a user may define a manner in which the consumer node should use the market data to control the consumption.

11. The consumer node of claim 7, configured to control the consumption in a manner defined by a central node.

12. The consumer node of claim 7 wherein control of the consumer devices is effected by the consumer node controlling all devices of the consumer site.

13. The consumer node of claim 7 wherein control of the consumer devices is effected by the consumer node instructing site sub-nodes each controlling one, or a subset, of the consumer devices.

14. A central node for facilitating efficient consumption of a consumable, the central node being operable to receive consumption data from a plurality of consumer nodes each associated with a respective consumer site and determine a collective consumption of the consumable across the plurality of consumer sites, the central node further being operable to participate in live markets in order to secure delivery of the consumable as required collectively across the plurality of consumer sites, and the central node further being operable to communicate market data conveying substantially live market effects to the consumer nodes for influencing consumption of the consumable.

15-16. (canceled)

17. The central node of claim 14, comprising a computer readable medium having computer readable program code embodied thereon, the computer readable program code comprising computer program code means for administering a plan entered into by a consumer with a retailer associated with the central node.

18. The central node of claim 15 wherein the central node comprises a computer readable medium having computer readable program code embodied thereon, the computer readable program code comprising computer program code means for aggregating a plurality of plans into a single pool of sufficient size for trading or over the counter arrangements with suppliers of the resource.

19. The central node of claim 14 wherein the central node comprises a computer readable medium having computer readable program code embodied thereon, the computer readable program code comprising computer program code means for administering sell back by the consumer of unused portions of the consumable as defined in the plan, and/or the purchase additional amounts of the consumable beyond the amount specified in the plan, and/or transfer or donation of amounts of the consumable to other parties.

20. The central node of claim 17 comprising computer program code means which provides for the retailer to offset a sell back by one consumer against a purchase by another consumer within a same futures pool, and/or provides for the retailer to turn to the markets to service consumer's change requests.

21-27. (canceled)
